(19) United States
(12) Patent Application Publication
(10) Pub. No.: US 2022/0178063 A1
(43) Pub. Date: Jun. 9, 2022

(54) METHOD AND APPARATUS FOR DIGITAL TEXTILE PRINTING

(71) Applicant: ALCHEMIE TECHNOLOGY LIMITED, Cambridge (GB)

(72) Inventors: Simon KEW, Preston (GB); Alan HUDD, Preston (GB); Thomas BLYTHE, Preston (GB); Haydee PACHECO, Preston (GB); Andi TAO, Preston (GB); Guolai TAO, Preston (GB)

(21) Appl. No.: 17/602,579

(22) PCT Filed: Apr. 9, 2020
(86) PCT No.: PCT/GB2020/050929

§ 371 Date: Oct. 8, 2021

(30) Foreign Application Priority Data
Apr. 9, 2019 (GB) 1905021.0

(51) Int. Cl. D06B 11/00; D06B 1/02; D06B 1/08; D06B 5/08; D06P 5/20; B41J 3/407

(52) U.S. Cl. CPC D06B 11/0059; D06B 1/02; B41J 3/4078; D06B 5/08; D06P 5/2083; D06B 1/08

(57) ABSTRACT

A method of digitally controlled application and fixation of dyestuff to a textile on a processing line is provided. The method comprising the steps of: determining one or more parameters of a textile; determining, by a processor, at least one dose setting for an array of flow channel dispensers of the processing line, wherein determining the at least one dose setting is based on the one or more parameters; dispensing, by the array of flow channel dispensers, dyestuff onto the textile according to the at least one dose setting and delivering energy to the substrate to fix the dyestuff in the textile.

### INTRODUCTION

The present invention relates to a method and apparatus for dispensing dyestuff onto a textile substrate, and, in particular, to a process design for textile dyeing using an array of independently digitally controlled flow channel dispensers and fixation energy sources on a processing line which eliminates the generation of waste water from wash-out and reduces energy costs.

Precision coating or dyeing is achieved through digital control of the flow channel dispenser orifices, such that 2D and 3D distribution of the industrial dyestuff fluid can be controlled to within a few percent of a target value. This principle of precision application of dyestuff fluids is applicable to many industrial materials. The technique utilises control of liquid application in combination with control of the surrounding airflow to achieve homogeneous three dimensional distribution of liquid dyestuff within a textile material.

Precision fixation is achieved through digital control of energy application using energy sources such as infra-red emitters such that the 2D and 3D distribution of energy can be controlled to deliver fixation within a few percent of a target value.

Currently, textile coating or dyeing is an environmentally damaging process, primarily due to the generation of significant volumes of waste water, typically many times the textile weight. Conventional processes for dyeing application are bath immersion methods such as exhaustion or jet dyeing, and padding with a roller-application mechanism. All conventional methods generally overdose the textile material with an excess of dyestuff, which has to be removed via repeated high temperature washes, generating large amounts of contaminated wastewater.

Contaminated wastewater, including water contaminated with dyestuffs is a considerable worldwide environmental issue and necessitates extensive waste water treatment to avoid environmental damage.

Traditionally, bath immersion coating or dyeing occurs to enable the absorption of the dyestuff to the fibre surface. Coatings or dyes can be substantially insoluble in water and require time and elevated temperatures to adsorb onto the fibre surface and diffuse into the fibre or react with the fibre to become entrapped or chemically bonded. Alternatively, coatings or dyestuffs can be applied to the textile via a roller “padding” process. The applied dyestuffs are then dried and heated in order to fixate the dyestuff. For both of these conventional methods of dyeing, washing is required in order to remove excess unbound dyestuffs and auxiliary chemicals. Washing typically involves several baths operated at elevated temperatures and can introduce additional chemicals, for example in the process of “reduction clearing” where a basic pH is used.

It is against this background that the new industrial process disclosed herein for textile dyeing without the need to perform a wash step. The process is based on the precise three-dimensional distribution of only the required amount of dyestuff and energy onto a textile substrate without the requirement for application of excess dyestuff to achieve dyed, fixed material. The disclosed approach enables a step-change in the sustainability profile of the industry through elimination or at least drastic reduction of waste water produced through washing processes.

According to the present invention, a method of digitally controlled application and fixation of dyestuff to a textile on a processing line is provided. The method comprising the steps of: determining one or more parameters of a textile; determining, by a processor, at least one dose setting for an array of flow channel dispensers of the processing line, wherein determining the at least one dose setting is based on the one or more parameters; dispensing, by the array of flow channel dispensers, dyestuff onto the textile according to the at least one dose setting; and delivering energy to the substrate to fix the dyestuff in the textile.

Furthermore, the method may comprise the steps of: determining one or more parameters of a textile to be dyed; determining, by a processor, at least one dose setting for an array of flow channel dispensers of the processing line, wherein determining the at least one dose setting is based on the one or more parameters; dispensing, by the array of flow channel dispensers, dyestuff onto the textile according to the at least one dose setting.

The method may also comprise the setting of a digitally controlled drying process that is determined by a processor based on one or more parameters of the textile to be dyed and one or more parameters of the dye application dose setting.

In addition, the method may also comprise the setting of a digitally controlled fixation process that is determined by a processor based on one or more parameters of the textile to be dyed and one or more parameters of the dye application dose setting.

Digital control of the array of flow channel dispensers may provide versatility such as real-time or near real-time colour inconsistency correction and/or near instant colour switching on the same processing line can be achieved. The application of dyestuff to a textile via an array of flow channel dispensers as opposed to, for example, the traditional method of soaking the textile in a disperse dye bath, allows for a deposition of exactly the correct dose of dyestuff according to the measured parameters of the textile

The application of energy for the purpose of fixation using a method that enables digital inputs to control the power and distribution of the energy applied e.g: infra-red, UV, radio-frequency or microwaves to enable precise dosing of energy. This is in comparison with traditional bath dyeing processes and continuous dyeing process wherein an excess of energy is typically applied to achieve fixation.

The application of dyestuff to a textile via an array of liquid dispensers as opposed to, for example, the traditional method of soaking the textile in a disperse dye bath, may allow for a deposition of exactly the correct dose of dye according to the absorption capacity of the textile, which can be determined based on measured parameters of the textile to be dyed. This entails a huge reduction in the amount of waste resources, such as water for dispersing the dye and the excess dye that is required to ensure a concentration gradient and the energy required for fixation and subsequent washing.

Furthermore, digital control of said liquid dispensers and energy emitters for fixation provides additional versatility such as inconsistency correction and near instant colour switching on the same processing line.

Determining the one or more parameters may comprise at least one of: receiving data input containing the one or more parameters; and detecting the one or more parameters using one or more sensors. Parameters that are input may be provided by the textile manufacturer or by preliminary offline assessments/tests. This allow for precise and controlled parameter details to be obtained in a bespoke environment.

The detection of the parameters of the textile using sensors reduces the risk of human error in entering and recording the parameters of a textile and the inherent possibility of error that might arise due to incorrect labelling of the textile.

The parameters of the textile may be detected in real-time or near real-time on the processing line, hence allowing for the real-time or near-real time detection of inconsistencies or errors in the textile. This enables dye and energy dose setting to be rapidly and independently adjusted by the processor and/or the prevention of continuous lengths of sub-optimal or inconsistent textile being dyed.

The one or more parameters may comprise at least one of: basis weight of the textile, absorbance capacity of the textile, water content of the textile, speed of the textile though the system, dyestuff concentration, textile thickness, textile diameter, textile batch code; colour; shade; pantone; reflectivity and any other textile surface optical property. Determining the one or more parameters may occur before the textile has been dyed, whilst the textile is being dyed and/or after the textile has been dyed. This approach enables a plurality of parameters to be measured throughout the process. A comparison between parameters measured at different points along the processing line can also be made, by the processor, to optimise the dose settings. This can increase the quality of the end product. For example, in a configuration where the two sides of the textile are not dyed simultaneously, determination of parameters may occur after a first side of the textile has been dyed, but before the second side of the textile has been dyed. Because the dye penetrates the fabric, the appearance of the first side of the fabric can be altered when the second side of the fabric is dyed. As a result, the dose setting for the second side can take into account the appearance of the first side following dyeing of that side.

In one embodiment, the method comprises the step of determining one or more parameters of a textile to be dyed.

Determining the parameters of the textile before it has been dyed, i.e. a textile to be dyed, enables the dose settings to be precisely selected in order to reflect the parameters of the textile to be dyed, hence increasing the quality and consistency of the dyed textile. Determining the parameters of the textile before it has been dyed also reduces the waste dye and waste textile that may arise from calibrating the flow channel dispensers each time a new textile is used.

In one embodiment, the method comprises the step of continuously determining one or more parameters of a textile to be dyed.

Continuously determining the parameters of the textile before it has been dyed allows for real-time or near real-time independent adjustments of the dose settings and/or the flow channel dispensers, hence intermittent inconsistencies or variations in the textile can be accounted for and the correct dose setting can be specified throughout the array of flow channel dispensers.

The dose settings may comprise at least one of: dyestuff colour, dyestuff concentration and quantity and/or flow rate dyestuff.

The quantity of dyestuff to be dispensed onto the textile may be equal to or below the saturated absorbance capacity of the textile, the saturated absorbance capacity being determined based at least in part on the one or more parameters.

Alternatively, the quantity of dyestuff to be dispensed onto the textile may be in excess of the saturated absorbance capacity of the textile, the saturated absorbance capacity being determined based at least in part on the one or more parameters.

The dose setting may be determined based at least in part on a target shade.

The step of dispensing may further comprise a feedback step of, in response to detecting, by at least one sensor, an area of textile surface containing a colour inconsistency, correcting the detected inconsistency.

Correcting the detected inconsistency may comprise adjusting the dose settings of dye or energy to prevent future inconsistencies. Alternatively, or in addition, the textile may be refed onto the processing line in order to correct any inconsistencies during a second application of dyestuff. Where the two sides of the textile are dyed separately, the dose settings for the second side can be altered to compensate for the sensed status of the first side of the textile.

Having a feedback and correction mechanism in the same processing line also reduces the overall complexity of the processing line apparatus and the time taken to arrive at a finished product since it eliminates the need for further quality checks and correction apparatus.

The colour inconsistency may be a colour inconsistency over the length of the textile i.e. the inconsistency varies over time. Alternatively, or in addition, the colour inconsistency may be a colour inconsistency across the width of the textile i.e. the inconsistency is consistent over time.

Correcting the detected inconsistency may comprise controlling, by the processor, a flow of atomised liquid dye of use of airflows to deflect dispensed dyestuff to compensate for undercoated areas of the textile surface.

Alternatively, or in addition, the processor may be used to dye two-dimensionally defined shapes to eliminate dyeing in areas of a textile that are not intended to be used in the final product. This process may occur in register on two sides of a duplex application. Dispensing the dyestuff onto at least one discrete location of a textile reduces the amount of dyestuff required. The dispensing location can be substantially similar to a desirable end product for the textile and therefore any locations or areas of the textile that are known to not require dye can be left undyed. The undyed textile can be more easily recycled or re-used. These locations may include locations that will become off-cuts and/or may include locations that will be unseen in a final product.

The at least one discrete location may be determined by the processor. Furthermore, the at least one discrete location may be a predetermined shape. The shape may cover the entire width and/or length of the textile. Alternatively, the shape may not cover the entire width and/or length of the textile. The shape may be the shape of a garment.

The method may comprise the step of determining, by the processor, an optimal or near-optimal layout of discrete locations configured to maximise the surface area of the textile to be dyed, wherein the layout comprises at least one discrete location of textile to be dyed.

The layout may comprise multiple discrete locations of textile to be dyed. Each discrete location may be identical. Alternatively, or in addition, each discrete location may vary. The discrete locations may vary in at least one of shapes, size, colour and form. The layout may comprise a combination of identical and varying discrete locations.

An optimal layout may comprise two or more tessellated shapes. Near optimal layouts will minimise the total area of undyed textile.

The method may further comprise the steps of determining, by the processor, at least one continuous boundary between a location of dyed textile and a location of undyed textile and detaching, by a detachment module, a portion of the dyed textile enclosed within the boundary.

The detached portion of dyed textile may be completely dyed. The detached portion of dyed textile may be of substantially the same shape as the discrete location of dyed textile. Alternatively, or in addition, the detached portion of dyed textile may be smaller than the location of dyed textile.

The detachment module may comprise a cutting mechanism, such as a guillotine or hole puncher.

The method may further comprise the steps of determining, by the processor, at least one continuous boundary between a location of dyed textile and a location of undyed textile and detaching, by a detachment module, a portion of the textile comprising the entirety of at least one boundary.

Detaching a portion of textile comprising the entire boundary will ensure that the remaining textile is either entirely dyed or entirely undyed. This allows the dyed textile to be further processed, as required, and the undyed textile to be recycled or reused.

The detached portion comprising the boundary may also comprise a strip of textile surrounding the boundary, wherein the strip may be a predetermined width.

Detaching a strip surrounding the boundary ensures that the remaining textile is either entirely dyed or entirely undyed. The predetermined width of the strip may be less than 1000, 500, 250, 100, 50, 25, 10, 5, 3 or 1 millimetre (mm). The predetermined width may be determined, by the processor, in real-time or near-real time. Alternatively, or in addition, the predetermined width may be an input of the processor.

The ultimate outcome of both applying dyestuff and performing fixation under digital control is that it is possible to produce dyed, fixed material that does not require washing to meet typical industry specifications.

The process of dye application may be achieved by spraying, inkjet printing or most preferably an array of independently controlled flow channel dispensers that generate an atomised spray of liquid dyestuff that is transported using an airflow.

The array of flow channel dispensers may be configured with their dispensing tips in close proximity to the textile substrate in order to deliver a substantially homogeneous application of liquid dyestuff to the textile.

The flow channel dispensers may be configured with their dispensing tips at a distance of between 5 mm and 50 mm from the textile surface.

The array of flow channel dispensers may comprise two sub-arrays of flow channel dispensers which dispense dyestuff onto opposing surfaces of the textile.

The array of flow channel dispensers may provide a substantial overlap in dispense area to achieve redundancy and dose averaging.

The airflow is most preferably configured such that it is applied to the side of the textile that is opposite to the dye application.

The processor may control each of the flow channel dispensers independently. Each individual dispensing element in an array of flow channel dispensers may be turned on and off by the processor. Furthermore, the amount of dyestuff being dispensed by each flow channel dispenser may also be controlled by the processor.

The independent control of each flow channel dispenser allows for a precise and localised adjustment of the dyestuff being dispensed. This enables an accurate and consistent target shade to be achieved even when the textile to be dyed has inconsistencies. In addition localised inconsistencies in the dyed textile may be prevented.

The flow channel dispensing tips may be in the form of ultrasonic atomiser nozzles.

The flow rate of dispensed dyestuff may be controlled using at least one of fluid pressure, nozzle duty cycle, ultrasonic energy, and positive displacement pumping, each of which may be controlled by the processor.

The dyestuff dispensed from the flow channel dispensers may be in the form of atomised droplets with a velocity greater than 5 ms⁻¹.

The atomised droplets may have a mean diameter in the range 1-50 microns.

The airflow may be in the range 50-500 kg hr-1 per meter width.

Atomised droplets travelling at such a velocity predominantly perpendicular to the substrate have been determined to sufficiently penetrate industrial textiles such that there is no requirement for further adsorption processes.

The method may further comprise the steps of detecting an inconsistency in the textile and controlling, by the processor, at least one of: a jetting frequency of one or more of the flow channel dispensers; an airflow applied to the dispensed dyestuff to adjust the flow rate; flow trajectory of dispensed dyestuff; power emitted by an energy source to compensate for the detected inconsistency. Digitally controlled variation the throughput liquid dispensers and an applied airflow provides a versatile and instantaneous mechanism for implementing the correction of flaws in the dyeing of the textile, all on the same processing line.

Detecting inconsistencies in the textile to be dyed enables each of the flow channel dispensers to be adjusted accordingly; hence producing a more consistent and homogenous dyed textile. Furthermore, inconsistencies may also be detected in the dyed textile and the dose setting of dye or energy adjusted accordingly, using the feedback mechanism, to prevent the inconsistencies from reoccurring.

The method may further comprise the steps of detecting an inconsistency in the array of flow channel dispensers and controlling, by the processor, at least one or more of the flow channel dispensers and/or an airflow applied to the dispensed dyestuff to adjust the flow rate or flow trajectory of dispensed dyestuff to compensate for the detected inconsistency.

An inconsistency in the array of flow channel dispenser, such as varied dyestuff flow rates, may result from blockages, partial blockages and/or air bubbles within the dispensing elements.

Alternatively, the method may comprise the steps of detecting an inconsistency in the array of flow channel dispensers and pausing, by the processor, the processing line entirely.

The identification of an error in the flow channel dispenser may result in the processing line being paused to prevent the continued production of substandard or inconsistent textile, hence saving both cost and time.

The method may further comprise the step of “bulk” fixing the dispensed dye onto the textile. The step of fixing may be done by application of dry air or steam with a temperature in the range 180° C. to 250° C. Alternatively or additionally, the step of fixing may be done by application of dry heat or steam in combination with application of radiation in the form of at least one of infrared, microwave and radiofrequency radiation.

The method may further comprise the step of dispensing, by the array of flow channel dispensers, dyestuff onto at least one discrete location of a textile.

Furthermore, according to the present invention there may also be provided apparatus configured to carry out the disclosed method, the apparatus comprising: a processing line for conveying a textile; a processor; and an array of flow channel dispensers, wherein each flow channel dispenser is independently controlled by the processor and configured to dispense dyestuff onto the surface of a conveyed textile.

The apparatus may comprise sensing means for detecting one or more parameters and/or one or more inconsistencies of a conveyed textile, and/or one or more boundaries between dyed and undyed textile.

The apparatus may further comprise a detachment module for separating the dyed and undyed portion of the textile.

The apparatus may further comprise fixing means for fixing dispensed dyestuff onto a conveyed textile.

The apparatus may further comprise a textile unwind module located at the beginning of the processing line and a textile re-wind module at the end of the processing line.

The method of the present disclosure is an industrial process for applying dyestuff fluids to a 2D or 3D substrate, for example, textiles and fabric, via a digitally controlled dosing system, with the advantage that the dyestuff is delivered in the region of the capacity of a textile substrate for absorption of coating. This can be done by, for example, detecting one or more parameters of the textile to be dyed such as the weight of the textile using a weight sensor. A processor then calculates the amount of dyestuff and fixation energy required to achieve a target shade for the textile based on the measured parameters. Accordingly, the method described herein can be used to reduce the need for immersion baths and for washing excess coating from the textiles.

A technical principle utilised by the present invention is the accurate measurement of parameters of a textile to be dyed and the determination, by a processor, of a dose setting for the textile based on the parameters. This process is followed by controlled application of dyestuff from an array of flow channel dispensers to deposit exactly the right amount of dye onto the textile surface.

Accordingly, the disclosed digital dyeing process is either wastewater free or low wastewater and enables a new manufacturing technology platform for on-demand digital dyeing of textiles. The technology eliminates or drastically reduces waste water emissions. The disclosed method also delivers manufacturing cost reductions and profitability benefits by, for example, reducing minimum dyeing “run” lengths and enabling rapid changeovers between different colours and textile materials.

The digital nature of the dosing control enables target dye shades to be delivered on a single processing line, for example in a configuration with a textile being unwound at the start of the processing line and re-rolled at the end of the processing line.

Advantages include the elimination of waste water through accurate dyestuff dosing. Reduction of wastewater is greater than 95% compared to conventional dyestuff application methods. Lowered dyestuff usage is also enabled, with up to a 30% decrease in the quantity of dyestuff and auxiliary chemicals required to dye a given textile, since excess dyestuff does not need to be applied to ensure a target shade is achieved. The disclosed method also achieves a reduced carbon footprint, with up to 80% energy saving when compared with conventional methods.

Alternatively, or in addition, the processor may determine one or more parameters of the dyed textile and provide real-time or near real-time feedback corresponding to the dose setting. The processor may determine the quality, accuracy and consistency of the dyed textile and can provided real-time or near real-time feedback to the dispensers. Near-real time may mean less than 10 milliseconds. This may enable the dose setting to be adjusted where necessary and/or the dispensing of dyestuff to be temporarily paused to prevent the production of significant lengths of faulty or inconsistently dyed textile. Furthermore, the digital nature of the disclosed process enables on-demand dyeing of textiles, and for precise target shades to be achieved on a textile substrate. Conventional methods, which require time-consuming textile pre-treatment and immersion, and which do not provide digitally controlled shading of textiles, do not allow for on-demand dyeing.

Yet another advantage is that a platform making use of the disclosed method can be operated at throughputs of more than 2000 square meters per hour, and is thus suitable for high throughput industrial production environments.

The process can achieve excellent colour consistency with delta e values of <0.5 variation across the textile web through the use of an array of digitally controlled flow channel dispensers. The process is capable of precision colour matching and shade control via digital control of the applied dose, and can be used with a wide range of fabrics.

An example technical specification of apparatus configured to carry out the disclosed method is provided in table 1.1:

| | |
|---|---|
| Throughput | >2000 square meters per hour |
| Maximum web width | 1.8 m |
| Minimum run length | 100 m |
| Maximum run length | 3000 m |
| Substrate basis weight | 50-800 gm⁻² |
| Substrates | Polyester, Polycotton, Nylon, Cotton |
| Water consumption | <0.5 tonnes/tonne of fabric |
| Energy consumption | <100 kW |
| Changeover time | <5 minutes |

The present invention will now be further described, by way of example only, with reference to the accompanying Figures in which:

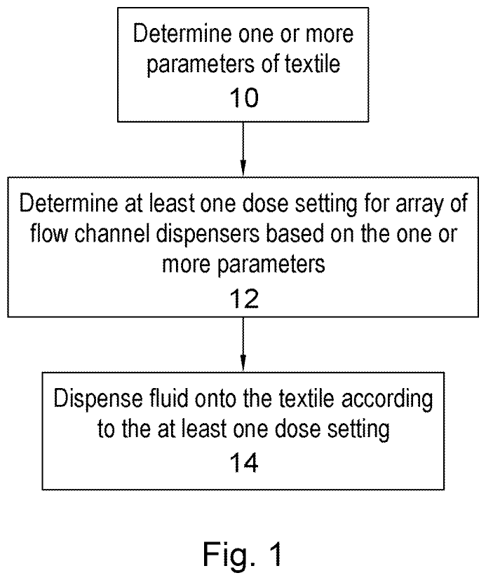

FIG. 1 shows a flow diagram of an example method according to the present invention;

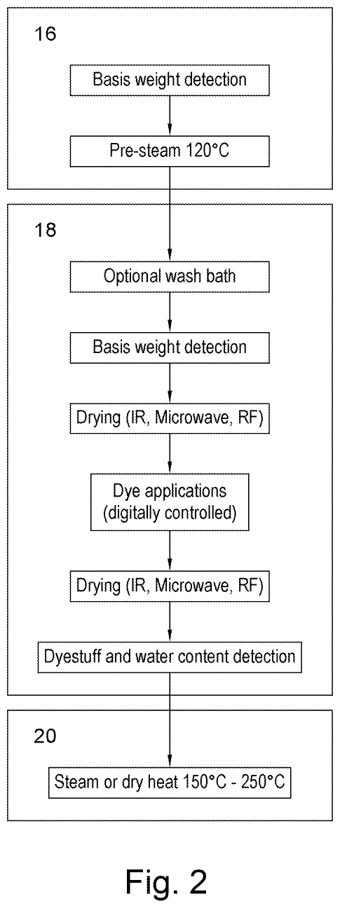

FIG. 2 shows a flow diagram of a detailed example workflow according to embodiments of the disclosed method;

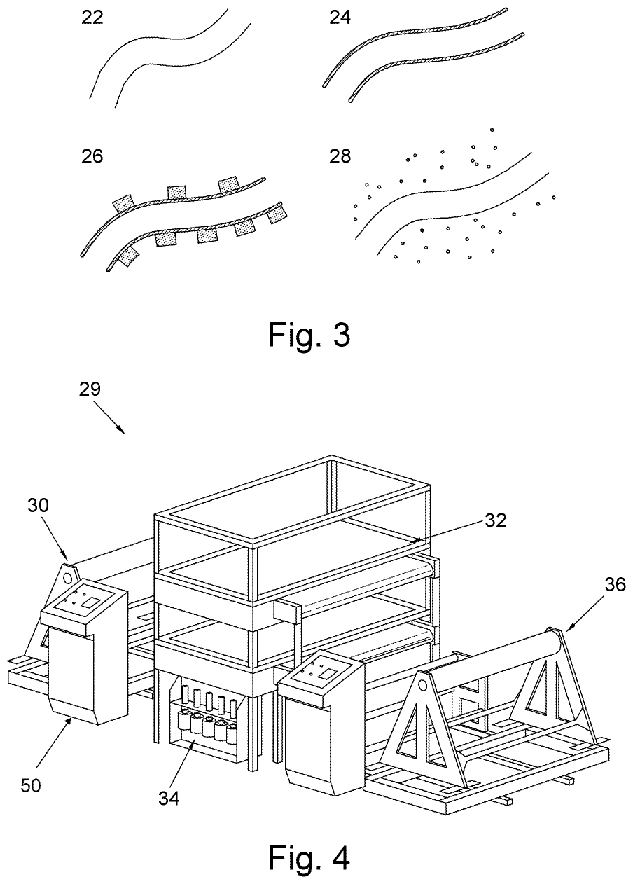

FIG. 3 shows an example textile fibre at different stages of dyestuff application;

FIG. 4 shows an example apparatus for carrying out the disclosed method;

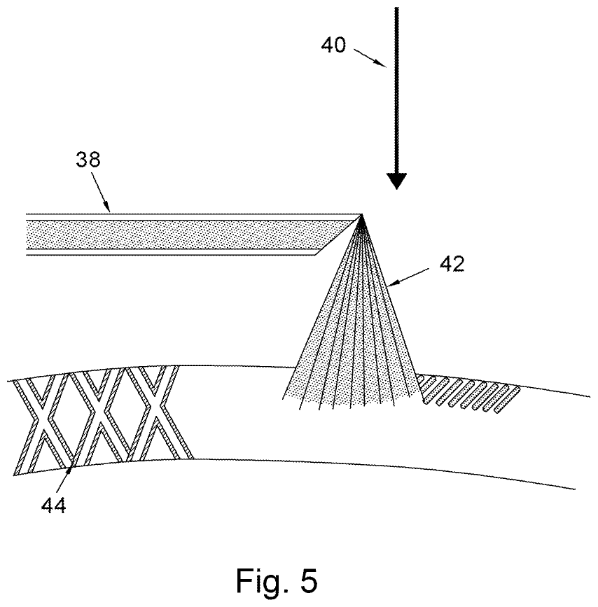

FIG. 5 shows an example configuration of a flow channel dispenser dispensing dyestuff onto a textile substrate.

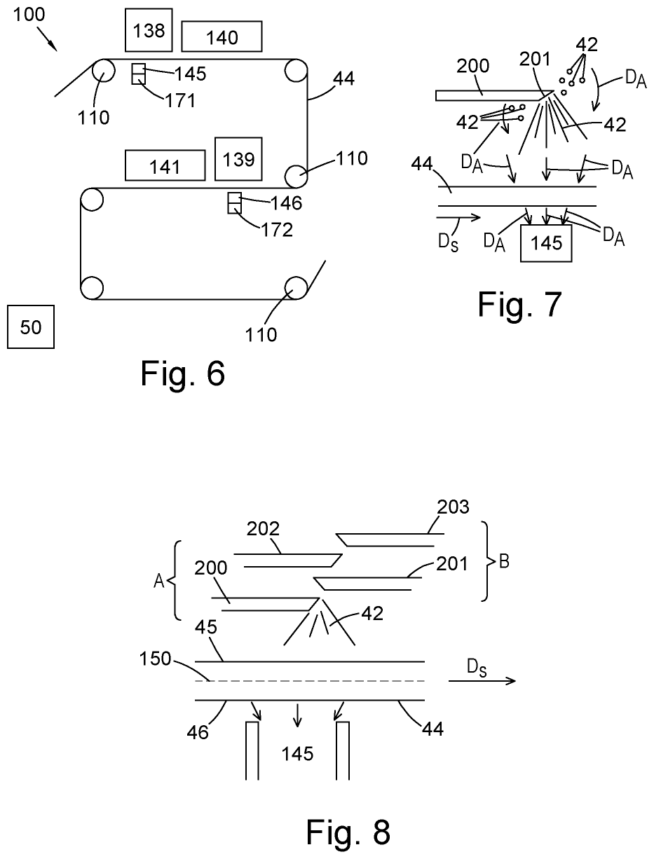

FIG. 6 shows an example processing line according to some embodiments of the present invention comprising a first pass and a second pass.

FIG. 7 shows an example configuration of a flow channel dispenser dispensing dyestuff onto a textile substrate with the addition of a vacuum chamber.

FIG. 8 shows an example textile substrate during the application of dyestuff on a first pass during a two pass processing line.

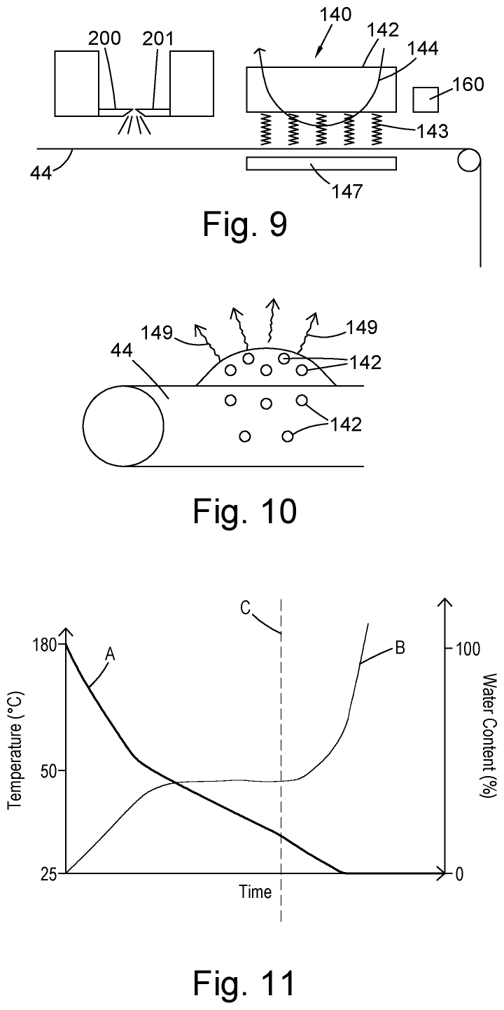

FIG. 9 shows an example of a drying stage within some embodiments of the processing line.

FIG. 10 shows an example textile substrate during the drying stage within some embodiments of the processing line.

FIG. 11 shows an example of how the water content of a dyestuff on a textile substrate may vary with respect to time when a change in temperature is applied.

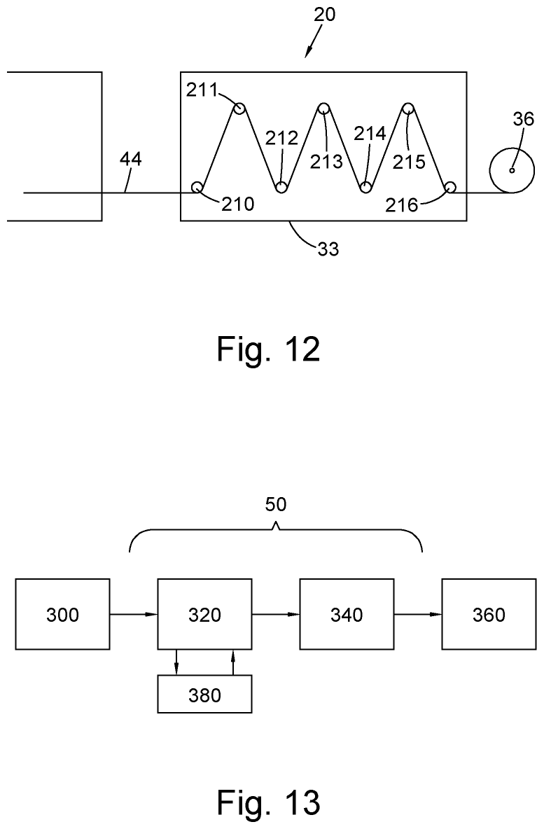

FIG. 12 shows an example of the fixing stage within some embodiments of the processing line.

FIG. 13 shows a flow diagram of an example method of the present invention.

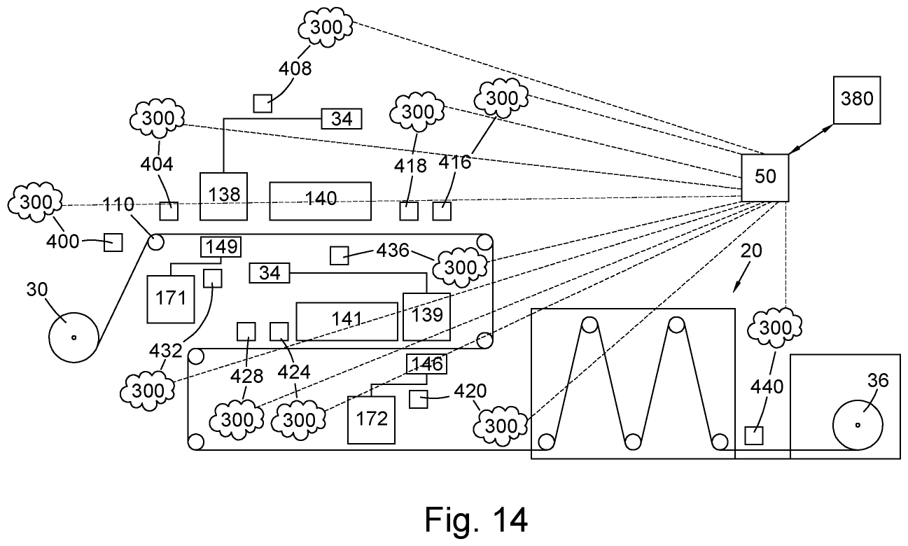

FIG. 14 shows an example processing line according to some embodiments of the present invention comprising at least one sensor.

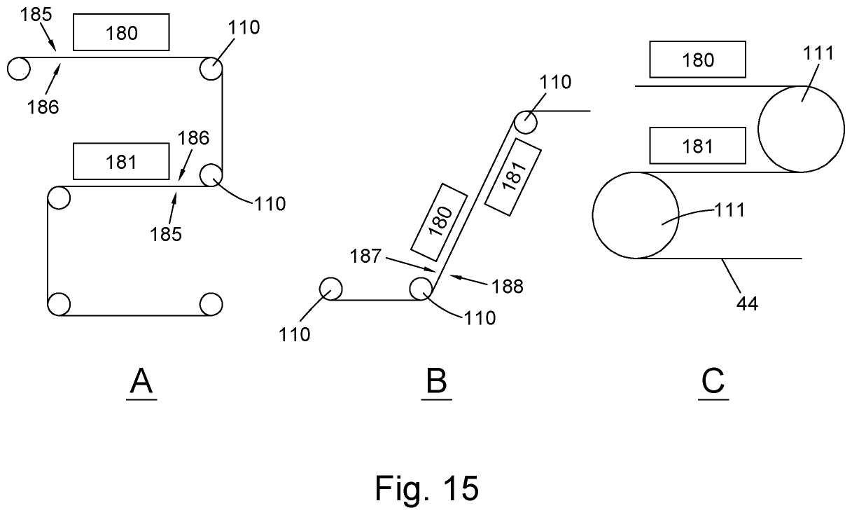

FIG. 15a shows an example processing line wherein the dyestuff is applied to a substantially horizontal surface of the textile substrate

FIG. 15b shows an example processing line wherein the dyestuff is applied to a substantially vertical surface of the textile substrate.

FIG. 15c shows an embodiment of the processing line comprising drums configured to determine the path of the textile substrate.

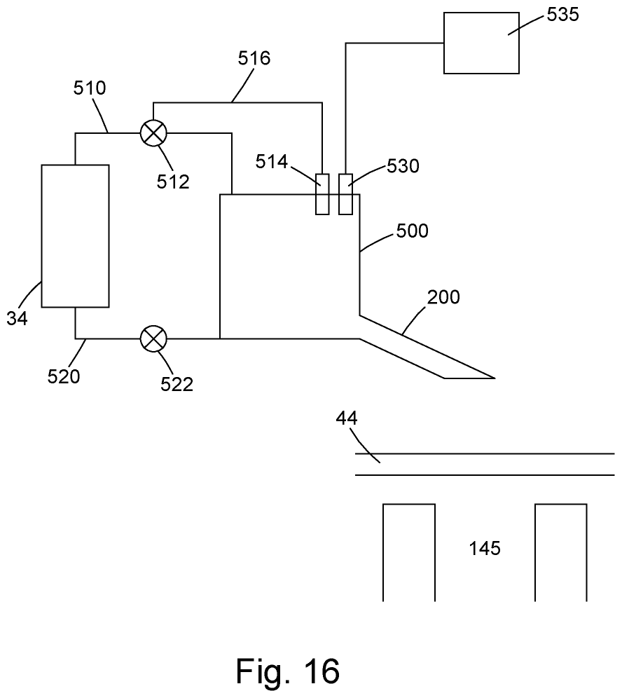

FIG. 16 shows an example dyestuff supply, circulation and drainage system for a dispensing element of the present invention.

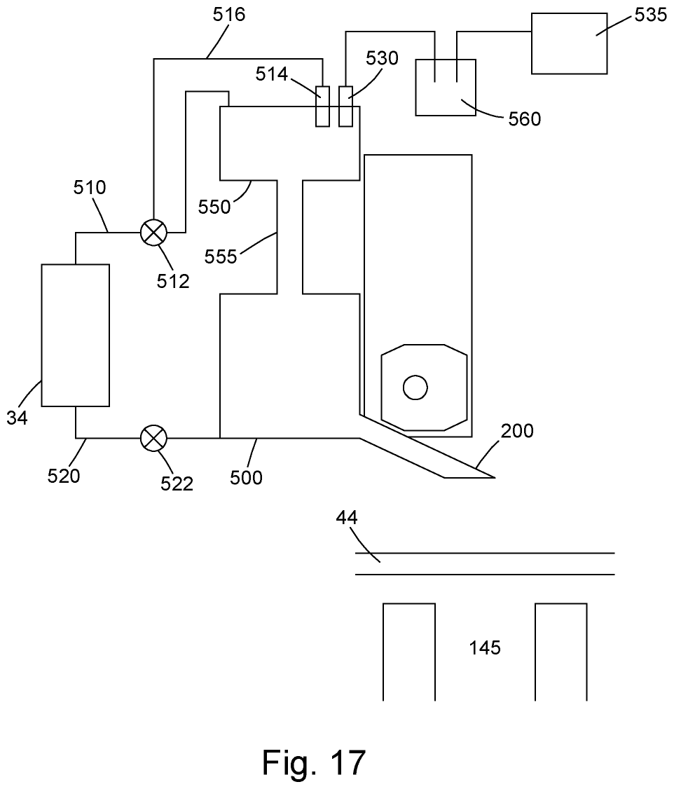

FIG. 17 shows an example dyestuff supply, circulation and drainage system for a dispensing element of the present invention comprising a header tank. In order further to explain various aspects of the present disclosure, specific embodiments of the present disclosure will now be described in detail in conjunction with the accompanying drawings. This description will be illustrative, rather than limiting.

Referring to FIG. 1, an example method according to the present invention comprises determination of one or more parameters of a textile 10 conveyed on a processing line. The determination can be done via user input, automatic input, or via digital sensing of one or more sensors on a processing line apparatus. Example parameters that can be input or sensed are: basis weight of the textile which is typically between 50 and 500 gm⁻², fibre denier/diameter of the textile, and textile weave type.

The illustrated method further comprises the step of determining at least one dose setting for an array of flow channel dispensers based on the one or more parameters 12 determined in the first step. The determination is performed by a processor 50, the processor being configured to control the array of flow channel dispensers. In some embodiments, the array of flow channel dispensers can comprise part of a printhead configured to dispense dyestuff.

The detection of the parameters of the textile using sensors reduces the risk of human error in entering/recording the parameters of a textile and the inherent possibility of error that might arise due to incorrect labelling of the textile.

Translation of the one or more parameters into a dose setting for the deposition of dyestuff fluid onto a textile surface enables deposition of fluid according to a maximum absorbance capacity of a textile conveyed on a processing line. This obviates the requirement for deposition of excess fluid onto the textile surface to ensure that a target shade is achieved, instead allowing exactly the correct amount of dyestuff to be deposited with minimal washing required afterwards. The determined dose setting is typically a mass flow rate per unit width (mL/min/m).

After the at least one dose setting has been determined, the method further comprises dispensing fluid onto the textile according to the at least one dose setting 14, for example, dyestuff fluid may be dispensed onto the textile surface according to a dose setting calculated to achieve a target shade for the textile.

In some embodiments, the method further comprises a closed feedback loop for in-line correction of inconsistencies in the textile that have not achieved the target shade. For example, a colour sensor can be used to detect a colour inconsistency in the textile and inform the processor 50. The colour sensor can be a camera or colour sensing can be carried out by fibre optic spectrometry. With an appropriate selection of sensor colour matching using LAB values can be achieved to an accuracy of delta e<0.5. Various methods can then be employed to correct the detected inconsistency, such as adjusting the digitally controlled flow channel dispensers by either modifying the jetting frequency of dispensed fluid or applying a flow of air to deflect dispensed fluid and compensate for the detected inconsistency.

Digitally controlled variation of a jetting frequency of the liquid dispensers, applied energy and/or an applied airflow provides a versatile and instantaneous mechanism for implementing the correction of flaws in the dyeing of the textile, all on the same processing line.

Having a feedback and correction mechanism in the same processing line also reduces the complexity of the overall dyeing process and the time taken to arrive at a finished product by eliminating the need for further quality checks and post-dyeing correction apparatus.

Referring to FIG. 2, an example workflow for a single dyeing “run” of a textile is illustrated.

The textile is unrolled and fed onto a processing line, then, at pre-treatment stage 16, the parameters of the textile are measured and sent to a processor 50. In this case, the determined parameter is the basis weight of the textile. The textile is then pre-treated by application of steam at 120° C., ensuring the surface of the textile is in a state in which dyestuff can be absorbed.

The next stage, which is a dye application stage 18, begins with an optional wash bath followed by a second basis weight detection to calculate the amount of steam and water that has been absorbed by the textile. Based on the second basis weight detection, controlled drying of the textile is performed until the textile contains a target water content. Drying is performed by at least one of: Infra-Red (IR) heating, Near Infra-Red (NIR) heating, Mid Infra-Red (MIR) heating, microwave heating.

When the textile is determined to be at the correct water content, dyestuff is applied by the digitally controlled array of flow channel dispensers. Optionally, at this stage, in line colour sensing and corrections may be applied to ensure a homogenous application of dyestuff is achieved on the textile surface. Further drying is then performed followed by a final sensing step to determine the water content and dyestuff absorption. Drying is performed by at least one of: Infra-Red (IR) heating, Near Infra-Red (NIR) heating, Mid Infra-Red (MIR) heating, microwave heating. The final sensing step may comprise a further measurement of basis weight.

The final stage of the dyestuff application process is an in-line fixing stage 20. Fixation of the dyestuff is performed via application of either steam or dry heat at elevated temperatures of approximately 150-250° C. to the dyed textile. Near instant spatial fixation of the dyestuff whilst the textile is on the same processing line has the advantage of avoiding dye migration after application of the dyestuff which is a problem with conventional methods.

In some embodiments, the in-line fixation process can also comprise application of at least one of: Infra-Red (IR) heating, Near Infra-Red (NIR) heating, Machine Infra-Red (MIR) heating, and microwave heating.

Referring to FIG. 3, an example textile fibre during various stages of the dyeing process is illustrated.

At a first stage of the process, the unmodified fibre 22 is measured to, for example, determine the basis weight of the textile. At a second stage of the process the textile is pre-hydrated and optionally immersed in water, leading to a fibre with a layer of increased water content at the surface 24. At a third stage of the process, a digitally controlled application of dyestuff is applied to the textile. The accuracy of the dose and deposition causes dyestuff to form a homogenous distribution across the surface of the pre-hydrated fibres 26. Finally, at a fourth stage of the process, the dyestuff is fixed to the textile, cementing the bond between the dyestuff and the fibre 28 and causing the accumulated layer of high water content to dissipate and evaporate. Referring to FIG. 4 an example processing line apparatus 29 for carrying out the disclosed method is illustrated.

The illustrated apparatus includes an unwind module 30 for unwinding a roll of textile prior to loading onto a conveyor belt comprised in the pre-treatment, dyeing and fixing enclosure 32. The array of digitally controlled flow channel dispensers 38 are comprised within enclosure 32 and are fed with dyestuff fluid to be dispensed onto a conveyed textile by a number of dyestuff supply tanks 34. Finally, at the end of the processing line is a re-wind module 36 for re-rolling the dyed and fixed textile once the process is complete.

The flow channel dispensers 38 are configured in an array of independently controllable digital elements to enable dose variation across the web of a conveyed textile and along the web of the textile. The dispensers are able to deliver liquid dyestuff at high velocity to fully penetrate the bulk of the textile

The array of flow channel dispensers 38 configured inside enclosure 32 can be configured as a single array or as two sub-arrays facing opposing sides of the conveyed textile. Flow channel dispensers configured in two sub-arrays have the advantage of being able to dispense dyestuff onto opposing surfaces of a conveyed textile, either simultaneously or in turn, without requiring two separate conveying processes for the textile. This enables a more efficient dyeing process, requiring less time to perform each run.

The flow channel dispensers 38 used to carry out the disclosed method can be selected from a number of types. For example, the flow channel dispensers may be comprised in a printhead configuration as disclosed in WO 2017/187153, the content of which is incorporated by reference herein. In other embodiments a spray coater with a digitally controlled mass flow controller or a slot-die coater with a digitally controlled mass flow controller of a digital inkjet printhead are used.

The array of flow channel dispensers 38 disclosed herein, which are based on those configured in the printhead disclosed in WO 2017/187153, are particularly suited to the present method. The array has the features of a digitally controllable dyestuff flow both in the conveyance direction and cross direction, highly accurate deposition, high cross-web homogeneity, the possibility of instant colour changeovers due to the digital control of the elements, and a high droplet velocity of greater than 5 ms¹ to ensure penetration into the textile and with the addition of a parallel airflow but without further adsorption encouraging steps.

Referring to FIG. 5, an example flow channel dispenser 38 of the array is shown dispensing atomised dyestuff droplets 42 onto the pre-hydrated fibres of a textile substrate 44.

Also illustrated is an air flow 40 being directed against the dispensing tip of the flow channel dispenser 38. The flow of air 40 is in a direction substantially perpendicular to the length of the flow channel dispenser 38 and substantially parallel to the direction of travel of dispensed fluid.

As mentioned above, in some embodiments of the disclosed apparatus, the flow of air 40 deflects droplets of fluid dispensed from the flow channel dispenser 38, and is thus capable of controlling a spread profile of the atomised droplets 42 of the dispensed fluid on the textile substrate 44.

Beneficially, controlling the droplet profile and spread enables the fluid to be dispensed at a higher resolution, and for detected inconsistencies in the textile substrate 44 to be rectified in-line. The velocity of the air flow can be controlled by the processor 50.

Furthermore, directing the flow of air 40 against the tips of the flow channel dispensers 38 reduces the risk of a known problem in printheads for dispensing other types of fluid such as inks, wherein dispensed fluid accumulates on the nozzle tips of dispensing elements and blocks the nozzles or reduces the homogeneity of the dispensed fluid.

The ability to deflect dispensed fluid with the flow of air 40 and thus control the spread area of the fluid onto the textile substrate 44 also allows real-time, versatile control of the application of dyestuff to a textile in-line.

In some embodiments, the air flow 40 is applied to the dispensed atomised droplets 42 periodically. For example, the processor 50 can cause the flow of air to be dispensed at a frequency in the range of 1-1,000 Hz.

Periodic deflection of the spray may be used to increase the averaging between adjacent nozzles and increase the homogeneity of dispensed fluid across the array of flow channel dispensers or to correct detected inconsistencies in the textile substrate 44 in-line.

In some embodiments, the air flow is driven at a pressure in the range 2-10 PSI or 14-69 kPa and at a flow rate of 1-100 cubic ft per minute or 0.00047-0.047 m³s⁻¹.

As described above, the array of flow channel dispensers are individually and independently controlled by a processor. Similarly, the flow of air 40 is regulated by an air flow controller (not illustrated), which in turn is digitally controlled by a processor 50.

Sensors for determining the one or more parameters of the textile and for detecting inconsistencies in the textile are also in communication with the processor 50. Alternatively, the sensors may be in communication with a different processor 50.

In an exemplary embodiment, the processor 50 corresponds to a microcontroller, a system on a chip or a single-board computer. The processor 50 includes a volatile memory, non-volatile memory, and an interface. In certain other embodiments, the processor 50 may include a plurality of volatile memories, non-volatile memories and/or interfaces. The volatile memory, non-volatile memory and interface communicate with one another via a bus or other form of interconnection. The processor 50 executes computer-readable instructions, e.g. one or more computer programs, for controlling certain aspects of the system described herein. The computer-readable instructions are stored in the non-volatile memory. The processor 50 is provided with power from a power source, which may include a battery.

### 1. Dye Application

### Fluid Delivery (Jetting [Nozzle 500 Um], Vacuum)

FIG. 6 shows an example processing line 100 comprising a first pass and a second pass. The first pass is defined by a first application of dyestuff via a first array of flow channel dispensers 138 and the second pass is defined by a second application of dyestuff via a second array of flow channel dispensers 139. Any number of passes and/or arrays of flow channel dispensers may be used, such as 3, 4, 5, 6, 8, 10 or more than 10 passes and/or arrays of flow channel dispensers.

In the example of the processing line shown in FIG. 6, the path of the textile substrate 44 is defined by a plurality of rollers 110. The rollers 110 define the turning points of the textile substrate 44 so that the overall length of the line is considerably shortly than the horizontal distance from the inlet to the outlet as the processing line 100 is convoluted by numerous folds in the textile substrate formed by the rollers 110. The rollers 110 comprise a hydrophobic outer surface and/or coating, such as Teflon, in order to prevent the transfer of aqueous dyestuff between the textile substrate and the roller 110, commonly known as offsetting.

The processing line 100 shown in FIG. 6 comprises a first 138 and second 139 array of flow channel dispensers that result in a two-pass process. The first array of flow channel dispensers 138 is followed by a first drying stage 140 and the second array of flow channel dispensers 139 is followed by a second drying stage 141. The first and second drying stage each comprise at least one of Infra-Red (IR) heating, Near Infra-Red (NIR) heating, Machine Infra-Red (MIR) heating, microwave heating, Ultraviolet (UV) heating and plasma heating. The processing line 100 further comprises a first vacuum chamber 145 beneath the textile substrate 44 beneath the first array of flow channel dispensers 138 and a second vacuum chamber 146 beneath the textile substrate 44 beneath the second array of flow channel dispensers 139. The first vacuum chamber 145 is connected to a first vacuum pump 171 and the second vacuum chamber 146 is connected to a second vacuum pump 172, wherein the first and second vacuum pumps are configured to control, via the processor 50, the flow of air generated by the each vacuum chamber.

FIG. 7 shows an example configuration of a flow channel dispenser 200 in a first array of flow channel dispensers 138 dispensing dyestuff onto a textile substrate 44 with the addition of at least one vacuum chamber 145. The direction of movement of the textile substrate 44 relative to the flow channel dispenser 200 and the vacuum chamber 145 is indicated by arrow Ds. The textile substrate may move at up to 25 meters per minute relative to the dispensing elements 138 and/or the vacuum chamber 145. The textile substrate can move at speeds of up to 100, 75, 50, 30, 25, 20, 15, 12, 10, 8, 5, 3, 2 or 1 meters per minute relative to the dispensing elements 138 and/or the vacuum chamber 145. Alternatively, the line 100 can be configured such that the textile substrate 44 moves less than 1, 0.8, 0.5, 0.3 or 0.1 meters per minute relative to the dispensing elements 138 and/or the vacuum chamber 145. The speed of the textile substrate can be adjusted either on a run-by-run basis or in real-time or near real-time during a dye run. For example, the textile substrate 44 can be moved at a speed of up to 35 meters per minute relative to the dispensing elements 138 and/or vacuum chamber 145. In particular, the textile substrate 44 can be moved at a speed of approximately 25 meters per minute relative to the dispensing elements 138 and/or the vacuum chamber 145.

The vacuum chamber 145 is configured to create airflow towards the vacuum chamber, indicated by arrows DA, such that the dyestuff droplets 42 are pulled towards the textile substrate 44. The addition of a vacuum chamber increases the volume of dispensed dyestuff that reaches the textile substrate 44 and significantly reduces overspray. In some embodiments, substantially all of the dispensed dyestuff reaches the textile substrate 44.

This reduces the maintenance require within the array of dispensing elements as the amount of dyestuff that coats internal members and elements of the system over time is significantly reduced or eliminated. The build-up of dyestuff on and/or around the dispensing tip may also be removed or significantly reduced.

The dispensing element 200 may be approximately 500 μm in diameter. In some embodiments, the dispensing element 200 may be up to 1000 μm, 800 μm, 600 μm, 500 μm, 400 μm, 200 μm or 100 μm in diameter.

The dispensing element 200 may comprise a tip 201 wherefrom the dyestuff may be dispensed. The tip of the dispensing element may be approximately 15 mm above the textile substrate. In some embodiments, the dispensing element may be up 30 mm, 25 mm, 20 mm, 17 mm, 15 mm, 13 mm, 10 mm, 5 mm or 1 mm above the textile substrate.

FIG. 8 shows an array of flow channel dispensers comprising a first bank of flow channel dispensers A and a second bank of flow channel dispensers B. Each bank of flow channel dispensers is configured to provide up to 500 dispensing elements per meter. Each bank of flow channel dispensers may comprise dispensing elements spaced at approximately 0.5 mm to 10 mm intervals. In some embodiments, the intervals are approximately 1 mm to 5 mm or 2 mm to 3 mm intervals. In some embodiments, each array of flow channel dispensers may comprise at least two banks of flow channel dispensers configure to provide dispensing elements spaced at approximately 1 mm to 2 mm intervals.

In some embodiments, each array and/or bank of flow channel dispensers may comprise a separate dyestuff supply tank. Each dyestuff supply tank may comprise a different colour, tone, shade, surface finish and/or functionality.

Alternatively, a plurality of arrays and/or banks of flow channel dispensers may comprise a single, shared dyestuff supply tank.

Each array of flow channel dispensers may be configured to dispense up to 200 g/m² of liquid dyestuff onto the textile substrate. In some embodiments, each array of flow channel dispensers may be configured to dispense up to 150 g/m²120 g/m²100 g/m²80 g/m²60 g/m² or 50 g/m² of liquid dyestuff onto the textile substrate. In some embodiments, each array of flow channel dispensers may be configured to dispense between 0 g/m² and 200 g/m², 5 g/m² and 1500 g/m² or 10 g/m² and 80 g/m² of dyestuff onto the textile substrate.

Alternatively, or in addition, the processing line may be configured to dispense between 3 and 5 litres of dyestuff per minute. In some embodiments, the processing line is configured to dispense between 2 and 8, 1 and 10 and/or 0 and 15 litres of dyestuff per minute.

Each dispensing element may be configured to dispense dyestuff at a velocity between 0 and 10 m/s. In some embodiments, the dispensing elements may be configured to dispense dyestuff at up to 1 m/s, 2 m/s, 5 m/s, 8 m/s, 10 m/s, 12 m/s, 15 m/s, 20 m/s, 25 m/s and/or 30 m/s.

The flow rate of each dispensing element may be accurate to within 1% of the desired flow rate. In some embodiments, the flow rate may be accurate to within 0.3%, 0.5%, 0.8%, 1%, 1.5%, 2, 5%, and/or 10% of the desired flow rate.

### Two Sided (Homogeneous Colour/Two-Tone/Coating [Two Functions, Colour, Finish])

FIG. 8 shows an example textile substrate 44 during the application of dyestuff on a first pass during a two pass processing line. The textile substrate may comprise a first surface 45 and a second surface 46, wherein the first pass is configured to dispense dyestuff onto the first surface and the second pass is configured to dispense dyestuff onto the second surface 46. The direction of movement of the textile substrate 44 relative to the flow channel dispensers 200, 201, 202, 203 and the vacuum chamber 145 is indicated by arrow Ds. The dyestuff droplets 42 are sprayed towards the first surface 45 of the textile substrate 44. The vacuum chamber 145 may be configured to generate a flow of air such that the dyestuff droplets 42 penetrate less than 100% of the way through the textile substrate, as shown by the dashed line 150.

In some embodiments, the vacuum chamber 145 may be configured to generate a flow of air such that the dyestuff droplets 42 penetrate up to 95%, 90%, 85%, 80%, 75%, 70%, 65%, 60% or 55% of the way through the textile substrate. The vacuum chamber 145 may be configured to generate a flow of air such that the dyestuff droplets 42 penetrate at least 50% of the way through the textile substrate. Preferably, the vacuum chamber 145 may be configured to generate a flow of air such that the dyestuff droplets 42 penetrate between 50% and 95% of the way through the textile substrate. Most preferably, the vacuum chamber 145 may be configured to generate a flow of air such that the dyestuff droplets 42 penetrate between 55% and 75% of the way through the textile substrate.

It is the intention to prevent the dyestuff from penetrating 100% of the way through the textile and thereby emerging from the second surface 46 of the textile substrate 44 and entering the vacuum chamber. Furthermore, it may also prevent the second surface 46 from receiving a dyestuff which may be transferred to downstream rollers 110, thus preventing ‘offsetting’.

The strength of airflow generated by the vacuum chamber is controlled to optimise the penetration of the dyestuff into different textile substrates. Depending on the textile and the dyestuff, optimisation of penetration may be set appropriately so that the dyestuff does not from penetrating through the textile substrate entirely.

During a second pass, as indicated in FIG. 6, dyestuff may be applied to the second surface 46 of the textile substrate 44. The dyestuff droplets 42 may be sprayed towards the second surface 46 of the textile substrate 44 and a vacuum chamber 146 may be configured to generate a flow of air such that the dyestuff droplets 42 penetrate less than 100% of the way through the textile substrate.

In some embodiments, the vacuum chamber 146 may be configured to generate a flow of air such that the dyestuff droplets 42 penetrate up to 95%, 90%, 85%, 80%, 75%, 70%, 65%, 60% or 55% of the way through the textile substrate. The vacuum chamber 146 may be configured to generate a flow of air such that the dyestuff droplets 42 penetrate at least 50% of the way through the textile substrate. Preferably, the vacuum chamber 146 may be configured to generate a flow of air such that the dyestuff droplets 42 penetrate between 50% and 95% of the way through the textile substrate. Most preferably, the vacuum chamber 146 may be configured to generate a flow of air such that the dyestuff droplets 42 penetrate between 55% and 75% of the way through the textile substrate.

Consequently, the two-pass process enables dyestuff to be applied throughout the entirety of the textile substrate thickness. The time between the first and second pass may enable to dyestuff to dry and/or fixate (where dyestuff molecules diffuse into the textile substrate) such that no offsetting occurs between the textile substrate and the rollers 110.

Furthermore, it is appreciated that the concentration of dyestuff applied at a given depth within the textile substrate thickness during the first pass will be less than the concentration of dyestuff applied to the first surface 45. However, during the second pass, dye stuff may again penetrate at least 50% of way through the total thickness of textile substrate and hence at least a portion of the textile substrate thickness may be re-coated. The penetration depth of the dyestuff during the first and second pass may be optimised such that the portion of textile substrate that receives dyestuff during both the first and second pass is also optimised. In some embodiments, none of the textile substrate receives dyestuff during both the first and second pass.

In some embodiments, the dyestuff applied during each pass may be different. The quantity i.e. shade, colour, finish and/or function of the dyestuff may vary between each pass.

A first quantity of dyestuff applied during the first pass may comprise a first colour, a first finish and a first function. A second quantity of dyestuff applied during the second pass may comprise at least one of a second colour, a second finish and/or a second function. Any number of passes may be used and any number and/or combination of colours, finishes and functions may be applied. The first and second quantity of applied dyestuff may be the same and/or may be different quantities. Applying a different quantity of dyestuff during the first and second pass may be used to control, alter and/or adjust the shade of the dyed textile substrate on the first 45 and second 46 surfaces.

For example, the colour, tones and/or shades of the dyestuff may, or may not, be varied between the arrays of dispensing elements. The finish of the dyestuff dispensed at each array of dispensing elements may be at least one of matt, shiny, glossy and/or textured, for example. Alternatively, or in addition, the dyestuff dispensed at each array of dispensing elements may provide at least one of water resistance, fire retardant and/or a fluorescent label, for example.

In some embodiments, each array of dispensing element may dispense the same dyestuff comprising the same colour, finish and functionality.

### Shapes/Width

In some embodiments, a textile substrate may be fed onto the processing line a plurality of times. Doing so would enable any number of different colours, finishes and functions to be applied to the textile substrate. Each flow channel dispensing element may be subjected to different dose setting during each subsequent processing of the textile substrate and combination of colours, patterns, finish, shades and/or pictures may be transferred onto the textile substrate.

In some embodiments, the amount of dyestuff dispensed from a single array of dispensing elements may vary along the width and/or length of the textile substrate. For example, some dispensing elements within an array may be adjusted, by the processor, such that they dispense a different amount of dyestuff compared to an adjacent dispensing element. In some embodiments, a plurality of dispensing elements may be configured to stop, either temporarily or permanently, dispensing entirely. This may be used to produce a textile with a pattern, such as horizontal and/or vertical stripes.

Alternatively, or in addition, each dispenser may be configured such that they can be alternated between and off and on position such that shape, patterns, discrete length and/or varying width of textile substrate can be subjected to dyestuff whist continuously feeding textile substrate onto the processing line.

In some embodiments, the array of flow channel dispensers is approximately 1.8 m wide. In some embodiments, the array of flow channel dispensers may be up to 0.1 m, 0.3 m, 0.5 m, 1 m, 1.5, 1.8 m, 2 m, 2.5 m, 3 m, 5 m, 10 m or more than 10 m wide. Each array of flow channel dispensers may be configured such that the width of dispensing elements that dispenses dyestuff, in use, may be up to 100%, 80%, 60%, 50%, 30%, 20%, 10%, or less than 10% of the total width of the array of flow channel dispensers.

In some embodiments, the processing line is configured to synchronise a shape and/or pattern that is dispensed by a second array of flow channel dispensing elements to a shape and/or pattern than was dispensed by a first array of flow channel dispensing elements. For example, with reference to FIGS. 6 and 8, a first T-shirt shape may be dispensed onto a first surface 45 of a textile substrate by the first array dispensing elements 138. Thus, the second array of dispensing elements 139 may be configured to dispense dyestuff in a second T-shirt shape onto the second surface 46 of the textile substrate such that the second T-shirt shape is dispensed onto the substantially same area but different surface of the textile substrate as the first T-shirt shape.

### Drying and Fixing in Line (Radiation/Energy [IR/nIR/UV/Plasma])

FIG. 9 shows an example of a drying stage of the processing line. The drying stage 140 comprises a drying unit 142 located above the textile substrate 44 and configured to discharge energy as electromagnetic waves 143. The drying unit may emit between 20 kW and 200 kW of energy. For example, the drying unit is configured to transfer approximately 50 kW of energy to the textile substrate. Consequently, a 90-150 kW drying unit may be used. The energy emit may be in the form of Infra-Red (IR), Near Infra-Red (NIR), Mid Infra-Red (MIR), microwave and/or Ultraviolet (UV). Alternatively, or in addition, plasma heating may also be used.

The drying unit 142 further comprises an airflow configured to remove any vapour and/or humidity away from the vicinity of the textile substrate 44. The airflow may be configured to remove up to 5 litres of water vapour per minute from the vicinity of the textile substrate. In some embodiments, the airflow is configured to remove up to 4, 3, 2, 1.5, 1 0.5 and/or 0 litres of water vapour per minute from the vicinity of the textile substrate. In some embodiments, the removed water vapour is disposed of as a waste product. In some embodiments, the waste water and/or heat is captured and recycled or reused.

The textile substrate may enter the drying stage with a water content of approximately 25%. In some embodiments, the textile substrate leaves the drying stage with a water content of 0%-5%. In some embodiments, the water content of the textile substrate that leaves the drying stage is between 2%-10%.

The drying stage comprises a reflector 147 located beneath the textile substrate and configured to optimise the amount of discharged energy that is transferred to the textile substrate 44.

The drying stage comprises at least one temperature sensor 160 configured to measure the temperature of the textile substrate 44 as it leaves the drying stage. The textile substrate enters the drying stage at approximately room temperature, which may be between 5° C. and 45° C. degrees, but more preferably may be between 10° C. and 35° C. degrees and most preferably may be between 15° C. and 30° C. During the drying stage, the textile substrate may increase in temperature by 5° C. to 60° C., and more specifically between 20° C. and 40° C. For example, the textile substrate may enter the drying stage at approximately 25° C. and leave the drying stage at approximately 60° C.

### Fixation in Application

FIG. 10 shows an example textile substrate 44 during the drying stage 140. The drying stage initially reduces the water content 149 of the dyestuff droplets 142. The removal of water content from the textile substrate and dyestuff droplets prevents a significant increase in temperature due to the latent heat of vaporisation required to evaporate the water, as shown in FIG. 11. Once the water content of the textile substrate has reduced to below approximately 10%, fixation of the dyestuff to/within the textile substrate begins to occur.

In some embodiments, the drying stage may be configured to at least partially fix the dyestuff to the textile substrate. The energy supplied by the drying unit 142 may be configured to locally energise at least a portion of the dyestuff which may have sufficient energy to react with or diffuse into the textile fibre. This may initiate a chemical or physical fixation process. Therefore, in some embodiments, Infra-red (IR) may be used to initiate the fixation process between the dyestuff and the textile substrate. More specifically, in some embodiments, Infra-red (IR) may be used to reduce the water content of a textile substrate comprising a dyestuff and concomitantly initiate the fixation process between the dyestuff and the textile substrate.

In some embodiments, the energy emitted by the drying unit may be controlled, adjusted and/or optimised. Furthermore, in some embodiments, the energy supplied by the drying unit may be non-uniform along the length of the drying unit. The amount, type and/or wavelength of energy may vary along the length of the drying unit. Doing so may enable the absorption of dyestuff, removal or water and/or fixation process between the dyestuff and the textile substrate to be optimised. For example, the drying unit may initially emit mid Infra-red wavelengths to the textile substrate in order to efficiently remove the water content from the textile substrate and the dyestuff. The drying unit may then change, further along the process, to emit near Infra-red (NIR) to efficiently initiate the fixation process between the dyestuff and a textile substrate, such as Polyester or Nylon.

Initiating and, in some embodiments, completing the fixation process during the drying stage may be used to entirely remove the necessity for a separate fixation stage at the end of the processing line. This can significantly reduce the time taken to process the textile substrate as incorporating fixation into the drying stage using electromagnetic waves such as IR may take approximately 0.5-10 seconds.

Completing the fixation of the dyestuff to the textile substrate during the drying stage may result in the textile substrate reaching temperature of up to 200° C., or above. Alternatively, or in addition, the time that the textile substrate spends in the drying stage may be increased up to 10 seconds in order to allow fixation be completed.

### Temperature (150° C.-240° C.)

FIG. 11 shows an example of how the water content of a dyestuff on a textile substrate varies with respect to time when a change in temperature is applied. Line A shows how the water content reduces with respect to time during the drying process. Line B shows how the temperature of the textile substrate varies with time during the drying process. Line C indicates the point at which fixation of the dyestuff to the textile substrate begins to occur. The substantially horizontal portion of line B i.e. minimal change in temperature of the textile substrate with respect to time occurs as a result of the energy required to overcome the latent heat of vaporisation of the water within the textile substrate and/or dyestuff.

### Chemistry

In some embodiments, the processing line may dispense a dyestuff comprising less than 10, 7, 5 or 3 components. At least one of the components may be at least one of a pigment and water. The dyestuff may be dispersed dyes, which are physically entrapped in hydrophobic fibres such as polyesters. The dyestuff may be fixed to the fibres using a binder, which thermally fuses with the fibres. The dyestuff may be fixed to the fibres using a chemical reaction, such as an acid-base electrostatic interaction. The dyestuff may be fixed via a precipitation reaction comprising two liquid components. All of, or substantially all of, the dispensed dyestuff will end up on the textile substrate and therefore a simplified chemistry is required. This contrasts with state of the art systems which use multiple washing steps to remove certain constituent parts of the dyestuff from the dyed fabric. A simplified chemistry may result in a cheaper dyestuff and may have significantly less impact on the environment due to fewer additives being required. Furthermore, the dyestuff may comprise and average dyestuff particle size (D₅₀) between 0.1 μm and 20 μm, 0.5 μm and 10 μm or 1 μm and 5 μm.

The dyestuff of the present invention may be used with any textile substrate, including polyester, cotton, nylon, polycotton, elastane and viscose, for example. The dyestuff of the present invention may be used with any dispensing means, including, spraying and inkjet printing, for example.

In some embodiments, the dyestuff is continuously recirculated within the dyestuff supply tank. Continuously recirculating the dyestuff within the dyestuff supply tank keeps the dyestuff particles suspended and therefore fewer auxiliary agents, such as levelling agents, are required. In some embodiments, the dyestuff may be a soft-settling suspension, i.e. a dispersion that can be re-suspended with fluid flow.

### 2. Completion of Fixation

FIG. 12 shows an example of the fixing stage 20 within some embodiments of the processing line 100. The textile substrate 44 enters a fixing enclosure 33 comprising a plurality of rollers 210 to 216 configured to define the path of the textile substrate through the fixing enclosure. Any number of rollers may be used within the fixing enclosure. Upon exiting the fixing enclosure, the textile substrate 44 is rolled onto the re-wind module 36.

The fixing enclosure is configured to enable the dyestuff to: diffuse further into the textile substrate, chemically react with the substrate; thermally fuse with the substrate. The fixation process may comprise at least one of solid state diffusion, gas phase sublimation, melting, chemical reaction, precipitation. For example, the dyestuff may undergo sublimation. In some embodiments, the sublimation of the dyestuff increases the efficiency with which the dyestuff diffuses into the fabric. Alternatively, in some embodiments, the sublimation of the dyestuff is prevented. Preventing the sublimation of the dyestuff may be achieved by reducing the temperate of the fixing enclosure and/or reducing the time spent by the substrate in the fixing enclosure.

### Control (Time)

The plurality of rollers 210-216 are configured to move relative to each other in order to extend or reduce the length of path the substrate must take within the fixing enclosure 33. For example, rollers 211, 213 and 215 move downwards towards rollers 210, 212, 214 and 216, and/or rollers 212 and 214 move upwards towards rollers 211, 213 and 215. Doing so decreases the length of path of the textile substrate 44 and therefore decreases the time the textile substrate spends within the fixing enclosure 33.

The textile substrate 44 may spend approximately 60 seconds in the fixing enclosure 33. In some embodiments, the textile substrate may spend up to 60, 90, 120 or 180 seconds in the fixing enclosure. In some embodiments, the textile substrate may spend less than 60, 50, 40, 30, 20, 10, 8, 6, 5, 3 or 1 second in the fixing enclosure. Reducing the time spent in the fixing enclosure may prevent a textile substrate 44, such as polyester, from shrinking and ensure good hand feel or “handle”.

The textile substrate may move along the processing line at approximately 25 meters per minute. Therefore, textile substrate may move through the fixing enclosure at approximately 25 meters per minute.

### Mechanical Control (Heat Settings/Stenter)

The bulk fixing enclosure 33 may be configured to be between 100° C. and 300° C. In some embodiments, the fixing enclosure is configured to be between 140° C. and 220° C. and in some embodiments the fixing enclosure is configured to be between 180° C. and 200° C. The temperature of the fixing enclosure 33 may be controlled and/or adjusted and therefore any temperature between room temperature and 300° C. is achievable.

In some embodiments, the fixing enclosure 33 may be filled with an inert gas. The inert gas may be Nitrogen and/or steam.

In some embodiments, the fixing stage further comprises a mechanical constraint, such as a stenter, configured to prevent the textile substrate from shrinking during the fixation process. The mechanical constraint may grip and/or stretch the textile substrate for duration of the fixation process to prevent it from shrinking.

### IR

In some embodiments, the fixing enclosure may comprise Infra-red (IR) or near infra-red (NIR) electromagnetic waves. This may significantly reduce the time taken during the fixing enclosure. For example, the time spent by the textile substrate in the fixing chamber may be less than 20 seconds. In some embodiments, the time spent by the textile substrate in the fixing chamber may be less than 15, 10, 8, 6, 5, 4, 3, 2 or 1 second.

In some embodiments the fixing chamber 33 is absent entirely. In such embodiments, the fixation process may occur entirely within the drying stage.

### 3. Digital Dyeing

FIG. 13 shows a flow diagram of an example method carried out by the processor 50. Input data 300 is input into the processor 50. The processor comprises an intelligence module 320 configured to determine at least one processor settings 340 based on the input data 300. The processor 50 then produces an output 360 based on the process settings 340.

### Intelligence (Fluid Application/IR/Fluid Fix)

The input data 300 may comprise at least one of: textile substrate basis weight (gsm); textile substrate water content (%); textile substrate thickness (mm); textile substrate gas permeability (H/m); textile substrate temperature (° C.) before, during and/or after a drying process; textile substrate colour (HU) before, during and/or after the dyeing a process; textile substrate colour (HU) before, during and/or after a fixation process; textile substrate temperature (° C.) (° C.) before, during and/or after a fixation process; textile substrate speed (m/s) throughout the processing line; dyestuff type; dyestuff concentration (mol); and dyestuff flow rate. In some embodiments, the input data may be calculated or measured on the processing line.

The intelligence module 320 may comprise a database 380 configured to store data. The database may store data configured to match input data 300 to at least one of processor settings 340 and processor output 360. For example, a given input or combination of inputs may require a specific combination of processor settings in order to produce a desired and/or optimal output. This combination of data may be stored within the data base such that the optimal output can be achieved quickly and efficiently. Doing so reduces the quantity of sub-optimal textile substrate and therefore reduces the time and cost to produce a finished textile substrate.

### Control

The processor settings 340 may comprise at least one of: flow rate (I/min) of dyestuff dispensed; amount of energy (J) supplied during the drying and/or fixing stage; and temperature (° C.) within the fixing enclosure. Each of these settings may be adjustable, in use, by the processor.

### Measurement

FIG. 14 shows an example processing line 100 comprising at least one sensor. The at least one sensor may be configured to determine input data 300. The input data may be determined before, during or after the dyeing process. The processing line comprises: a first sensor 400 configured to determine the basis weight of the textile substrate; a second sensor 404 configured to determine the water content of the textile substrate; a third sensor 408 configured to determine the flow rate of dyestuff being dispensed by a first array of flow channel dispensers 138; a fourth sensor 412 configured to determine the temperature of the textile substrate after a first drying stage 140; a fifth sensor 416 configured to determine the colour of the textile substrate after a first drying stage 140; a sixth sensor 420 configured to determine the flow rate of dyestuff being dispensed by a second array of flow channel dispensing elements a 139; a seventh sensor 424 configured to determine the temperature of the textile substrate after a second drying stage 141; an eighth sensor 428 configured to determine the colour of the textile substrate after a second drying stage 141; a ninth sensor 432 configured to determine the flow rate of a first vacuum chamber 145; a tenth sensor 436 configured to determine the flow rate of a second vacuum chamber 146; and an eleventh sensor 440 configured to determine the colour of the textile substrate after the fixing stage 20.

FIG. 15a shows a processing line 100 wherein the dyestuff is applied to a first and second substantially horizontal surface of the textile substrate. The processing line comprises a first dyeing and drying/fixing stage 180 configured to dye a first substantially horizontal surface 185 of the textile substrate and a second dyeing and drying/fixing stage 181 configured to dye a second substantially horizontal surface 186 of the textile substrate. In between the first and second dyeing and drying/fixing stages 180, 181, the textile substrate is flipped over using a plurality of rollers 110.

FIG. 15b shows an example processing line wherein the dyestuff is applied to a substantially vertical surface of the textile substrate. The processing line comprises a first dyeing and drying/fixing stage 180 configured to dye a first surface 187 of the textile substrate and a second dyeing and drying/fixing stage 181 configured to dye a second surface 188 of the textile substrate. The first 180 and second 181 stages are provided on the same span of textile substrate, i.e. without the rollers 110 changing the fabric direction between the first 180 and second 181 stage. The rollers 110 are configured so that the textile substrate is moving at approximately 45° to the horizontal so that neither the first stage 180 nor the second stage 181 is too close to the vertical. This is because it is easier for the dye to be at least partially gravity fed. Although the illustrated example shows the first and second stages 180, 181 offset, it is also possible to align them so that the fabric is simultaneously dyed from both sides.

FIG. 15c shows a processing line 110 comprising drums 111 configured to determine the path of the textile substrate 44. Using drums 111 instead of rollers 110 increases the contact area with the substrate and decreases the total number of moving components on the processing line.

### Changeover (Fluids)

FIG. 16 shows an example dyestuff supply, circulation and drainage system fora dispensing element of the present invention. The flow channel dispenser 200 is in fluid communication with a dyestuff holding tank 500 configured to contain liquid dyestuff. Initially, the dyestuff holding tank 500 may be empty of dyestuff. The holding tank 500 is in fluid communication with a supply tank 34 via a supply inlet 510 and a return outlet 520. The supply inlet 510 comprises an inlet pump 512 operably connected to a holding tank level sensor 514 via a wire 516. The holding tank level sensor 514 is configured to monitor the level, and hence volume, of dyestuff in the holding tank 500. The inlet pump 512 is turned on in order to pump dyestuff from the supply tank 34 and to the holding tank 500. The pump 512 is then turned off once the level in the holding tank 500 reaches a predetermined level. The system is then ready for use.

When the level and/or volume of dyestuff in the holding tank falls below a predetermined level and/or volume, the level sensor 514 issues an alert which is configured to turn on the pump 512 and pump dyestuff from the supply tank 34 to the holding tank 500 via the supply inlet 510. Once the level and/or volume of dyestuff in the holding tank reaches the predetermined level and/or volume, the level sensor 514 sends an alert to the pump 512 to turn off, hence preventing the over-supply of dyestuff. This process may be continuously operated such that when dyestuff is being dispensed from the dispensing element 200 the level and/or volume of dyestuff in the holding tank remain substantially constant.

The holding tank further comprises a return outlet 520 including an outlet pump 522 configured to pump dyestuff from the dyestuff holding tank 500 to the supply tank 34.

The supply inlet 510 and inlet pump 512 may be turned off/closed. The return outlet 520 and outlet pump 522 is then configured to drain substantially all of the dyestuff from the holding tank 500. This enables the supply tank 500 and dispensing element 200 to be cleaned, maintained and/or for the dyestuff colour, surface finish, functionality and/or any other property to be changed. For example, the supply tank 34 may be swapped with a new supply tank.

In some embodiments, the supply inlet 510 and the return outlet 520 operate simultaneously. This enable a continuous recirculation of the dyestuff from the supply tank 34 to the holding tank 500 and back again. When the dispensing element is in use, the supply inlet 510 may have a greater flow rate than the return outlet 520 such that the level and/or volume of dyestuff in the holding tank remain substantially constant. The flow rate in the return outlet 520 may be approximately 50 ml/min. alternatively, or in addition, the flow rate in the return outlet 520 may be approximately 10% of the flow rate of the supply inlet 510. Recirculating the dyestuff using the supply inlet 510 and return outlet 520 may be used to keep the particles within the dyestuff in suspension, hence reducing the number of additives or agents required in the dyestuff.

In some embodiments, the level and/or volume of dyestuff in the holding tank 500 may vary. In some embodiments, the level sensor is configured such that it alerts the inlet pump 516 when the level of dyestuff in the holding tank 500 reaches a level below a predetermined threshold. The predetermined threshold level may be level with the top of the dispensing element 200.

In some embodiments, the holding tank 500 comprises a vacuum inlet 530. The vacuum inlet 530 is connected to a vacuum pump 535 configured to create a negative pressure in the holding tank 500. The negative pressure in the holding tank may be configured to prevent dyestuff from being dispensed from the dispensing element 200. For example, as the holding tank 500 fills with dyestuff, the dispensing element 200 will also begin to fill with dyestuff. At a certain point, when the holding tank is partially filled, the dispensing element 200 will be full. However, through the careful control of the negative pressure created by the vacuum inlet 530 in the holding tank 500, the dyestuff can be prevented from dripping and/or being dispensed from the dispensing element, hence enabling the holding tank 500 to be filled to the desired level.

In some embodiments, once the holding tank 500 and/or dispensing element 200 comprises a desired amount of dyestuff, the negative pressure in the holding tank may be reduces such that the dispensing element dispenses a predetermined amount of dyestuff. This can be used to ensure system is operation effectively and efficiently in addition to confirming the correct dyestuff is present within the system.

In some embodiments, the vacuum inlet 530 is configured to create a negative pressure in the holding tank 500 such that dyestuff is prevented from enter the dispensing element 200 entirely.

FIG. 17 shows an example dyestuff supply, circulation and drainage system for a dispensing element comprising a holding tank 500. The holding tank 500 comprises a header tank 550 in fluid communication with the holding tank 510 via a conduit 555. The vacuum inlet 530 and supply inlet 514 may be connected to the header tank 550.

The vacuum inlet 530 is in fluid communication with a drip tank 560 configured to collect any dyestuff that is inadvertently sucked into the vacuum inlet 530. The drip tank 560 is configured to prevent dyestuff from entering the vacuum pump 535.

At least one of the supply inlet 510, supply pump 512, holding tank 500, conduit 555, header tank 550, return outlet 520 and outlet pump 522 is coated with a hydrophobic material, such as Teflon®. The coating is applied to any surface that is intended to be in fluid contact with the dyestuff.

The changeover method deployed can be varied according to the requirements of specific dyestuffs and textiles to be dyed. However, the process broadly includes the switching off of the supply pump 512 and the outlet pump 522 being initiated to remove all remaining dyestuff from the header tank 550. A wash cycle can then be initiated in which water and detergent are introduced into and then flushed from the header tank 550. Depending on the nature of the dyestuff and, in particular, the colour of the dyestuff, one or more wash cycles can be provided. The dosing of detergent in each wash cycle can be modified with the maximum detergent provided in the first wash cycle and the least detergent provided in the final wash cycle. Indeed, the final wash cycle can be achieved with no detergent at all. Once the final wash cycle has been completed, the header tank 550 can be refilled with the new dyestuff. In relation to the selection of the number of wash cycles, the colour of the two dyestuffs, before and after the changeover, can be taken into consideration. For example, changing from yellow dye to black may be achievable with a single wash cycle, whereas changing from black dye to yellow may require three wash cycles.

1. A method of digitally controlled application and fixation of dyestuff to a textile on a processing line, the method comprising:
determining one or more parameters of the textile;
determining, by a processor, at least one dose setting for an array of flow channel dispensers of the processing line, wherein determining the at least one dose setting is based on the one or more parameters;
dispensing, by the array of flow channel dispensers, dyestuff onto the textile according to the at least one dose setting; and,
delivering energy to the textile to fix the dyestuff in the textile.

2. The method of claim 1, wherein the one or more parameters comprise parameters of the textile to be dyed or the dyed textile.

3. (canceled)

4. The method of claim 1 any preceding claim, wherein the one or more parameters are determined in real-time or near real-time.

5. The method of claim 1 any preceding claim, wherein the one or more parameters are determined continuously.

6. The apparatus of claim 35, wherein each of the flow channel dispensers are controlled independently.

7.-13. (canceled)

14. The apparatus of claim 35, wherein the array of flow channel dispensers comprises two sub-arrays of flow channel dispensers which dispense dyestuff onto opposing surfaces of the textile.

15.-18. (canceled)

19. The method of claim 1, wherein the fluids applicator is a spray system or inkjet print head.

20. (canceled)

21. The method of claim 1, further comprising controlling the flow rate of dispensed dyestuff using at least one of pressure, ultrasonic energy, and positive displacement pumping, using the processor.

22. (canceled)

23. The method of claim 1, further comprise the steps of:
determining, by the processor, an optimal or near-optimal layout of discrete locations of textile to be dyed, wherein the layout is configured to maximise the surface area of the textile to be dyed, and
dispensing, by the array of flow channel dispensers, dyestuff onto the at least one discrete location.

24. The method of claim 23, further comprising the steps of determining, by the processor, at least one continuous boundary between a location of dyed textile and a location of undyed textile, wherein the continuous boundary encloses the location of dyed textile, and detaching, by a detachment module, a portion of the dyed textile enclosed within the boundary.

25. The method of claim 23, further comprising the steps of determining, by the processor, at least one continuous boundary between a location of dyed textile and a location of undyed textile and detaching, by a detachment module, a portion of the textile comprising the entirety of the at least one continuous boundary.

26. The method of claim 25, wherein the detached portion comprising the continuous boundary also comprises a strip of textile surrounding the boundary, wherein the strip is a predetermined width.

27. The method of claim 1, further comprising the steps of:
detecting an inconsistency in the textile; and
either controlling, by the processor, at least one of a jetting frequency of one or more of the flow channel dispensers and an airflow applied to the dispensed dyestuff to adjust the flow rate or flow trajectory of dispensed dyestuff to compensate for the detected inconsistency, or
pausing, by the processor, the processing line entirely.

28. The method of claim 1, wherein determining the one or more parameters comprises at least one of: receiving a data input containing the one or more parameters; and detecting the one or more parameters using one or more sensors.

29. The method of claim 1, wherein the one or more parameters comprise at least one of: basis weight, speed, dyestuff concentration, substrate thickness, diameter, textile batch code, adsorbance capacity, water content, colour, shade, pantone, and reflectivity.

30. The method of claim 1, wherein the dyestuff dispensed from the flow channel dispensers is in the form of atomised droplets with a velocity greater than 5 ms-1.

31. The method of claim 1, wherein the method further comprises the step of fixing the dispensed dye onto the textile using steam with a temperature in the range 150° C. to 250° C. or radiation, including at least one of infrared, microwave and radiofrequency radiation.

32.-34. (canceled)

35. Apparatus configured to carry out the method of digitally controlled application and fixation of dyestuff to a textile on a processing line, the method comprising:
determining one or more parameters of a textile;
determining, by a processor, at least one dose setting for an array of flow channel dispensers of the processing line, wherein determining the at least one dose setting is based on the one or more parameters;
dispensing, by the array of flow channel dispensers, dyestuff onto the textile according to the at least one dose setting; and,
delivering energy to the substrate to fix the dyestuff in the textile
the apparatus comprising:
a processing line for conveying a textile;
a processor; and
an array of flow channel dispensers, wherein each flow channel dispenser (38) is independently controlled by the processor and configured to dispense dyestuff onto the surface of a conveyed textile (44).

36. The apparatus of claim 35, further comprising sensing means for detecting one or more parameters and/or one or more inconsistencies of a conveyed textile.

37. The apparatus of claim 35, further comprising fixing means for fixing dispensed dyestuff onto a conveyed textile.

38. (canceled)

39. The method of claim 1, wherein an airflow is used to direct a liquid droplet into the internal structure of a textile substrate.

40. The method of claim 1, wherein the surface tension of the liquid dyestuff is controlled in order to affect fluid spreading after application to a textile substrate.

41. (canceled)
